(19) United States
(12) Patent Application Publication
(10) Pub. No.: US 2014/0169997 A1
(43) Pub. Date: Jun. 19, 2014

(54) POWER UNIT TO MOVE AT LEAST A HYDRAULIC ACTUATOR

(71) Applicant: BUCHER HYDRAULICS S.P.A., REGGIO EMILIA (RE) (IT)

(72) Inventor: LUCA IBATICI, REGGIO EMILIA (IT)

(73) Assignee: BUCHER HYDRAULICS S.P.A., REGGIO EMILIA (RE) (IT)

(21) Appl. No.: 14/103,112

(22) Filed: Dec. 11, 2013

(30) Foreign Application Priority Data
Dec. 19, 2012 (EP) 12425202.4

(51) Int. Cl. F15B 15/18

(52) U.S. Cl. CPC F15B 15/18
USPC 417/410.4; 417/410.1

(57) ABSTRACT

Power unit (101) comprising:
a tank (104) for hydraulic oil;
an electric motor (105);
a power pack body (102) inside of which a hydraulic circuit extends;
a hydraulic pump (103) integrated in a cavity (102a) of the power pack body (102).

The subject matter of the present invention is a power unit to move at least a hydraulic actuator.

A power unit or mini power pack is generally made up of a power pack body, a hydraulic pump, a tank and a motor.

According to known solutions, the power pack body and the hydraulic pump are two distinct physical units. More specifically, the hydraulic circuit extends in the power pack body with one or more valves internally thereof, whereas in the hydraulic pump, there are components such as gears, bushings, gaskets, etc.

By connecting the pump to the tank and to the motor (or to a pulley or more generically, to a component that is capable of setting it into rotation), a suction line and a delivery line are created and complete the hydraulic circuit.

In the known solutions, the power pack body and the hydraulic pump thus work in combination to make available a complete power unit suitable for moving actuators such as hydraulic cylinders and/or motors for example.

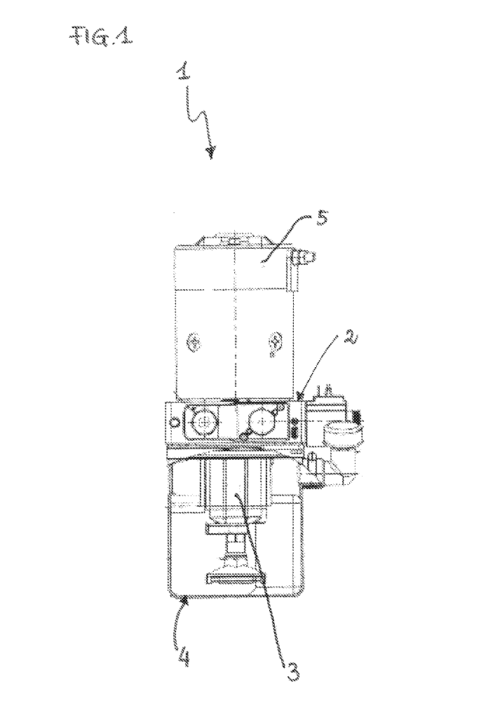

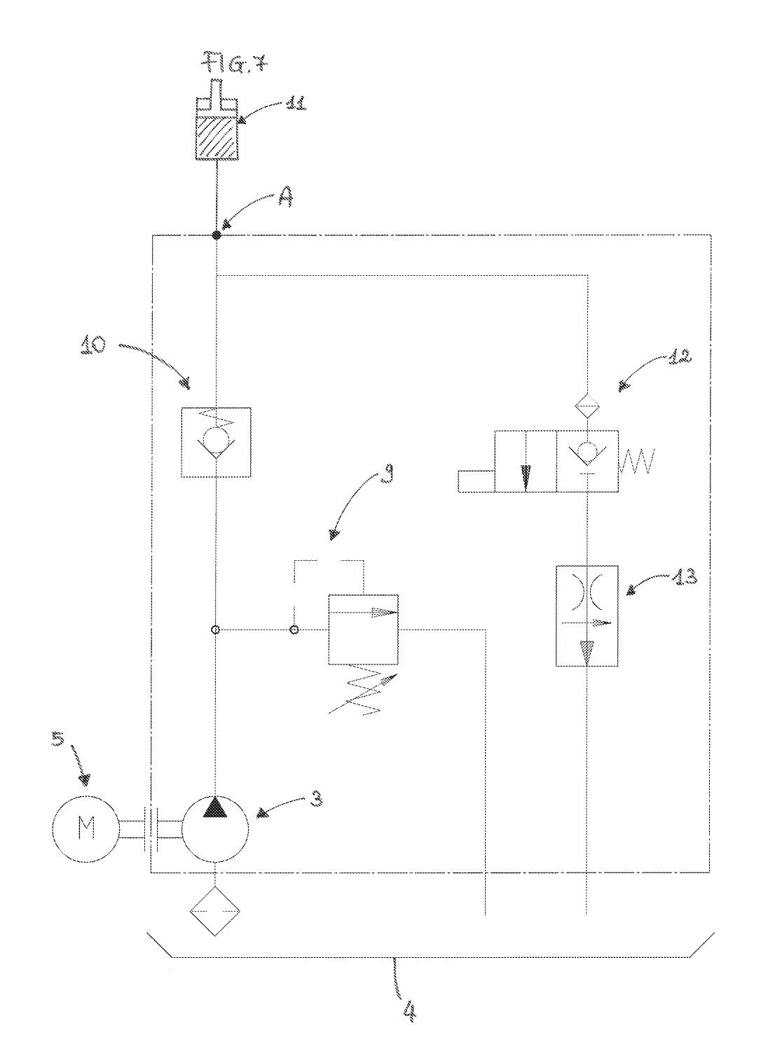

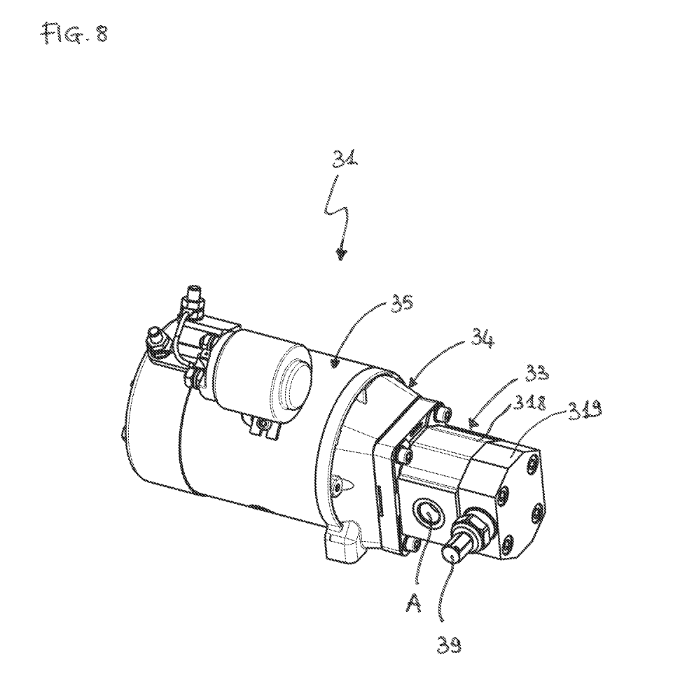

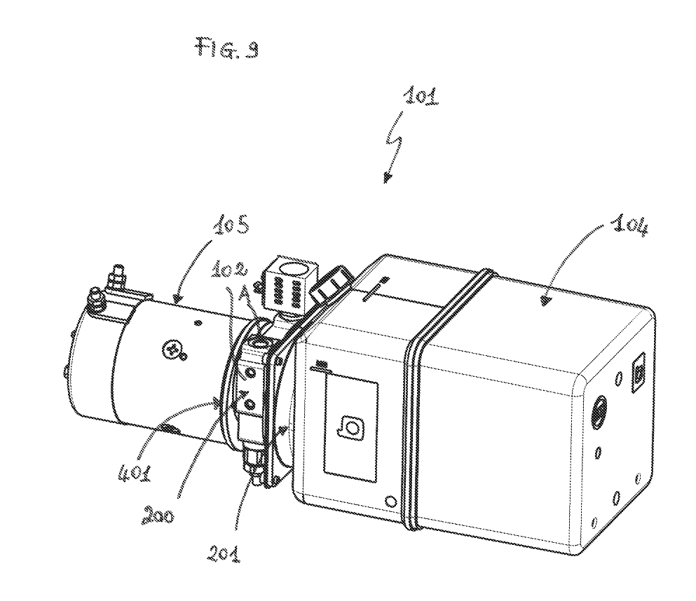

It is held that providing a detailed description of two solutions of the prior art that are closest to the invention is useful for a full understanding of the scope of the invention proposed herein; these solutions are illustrated in FIGS. 1 to 7, and in FIG. 8, respectively.

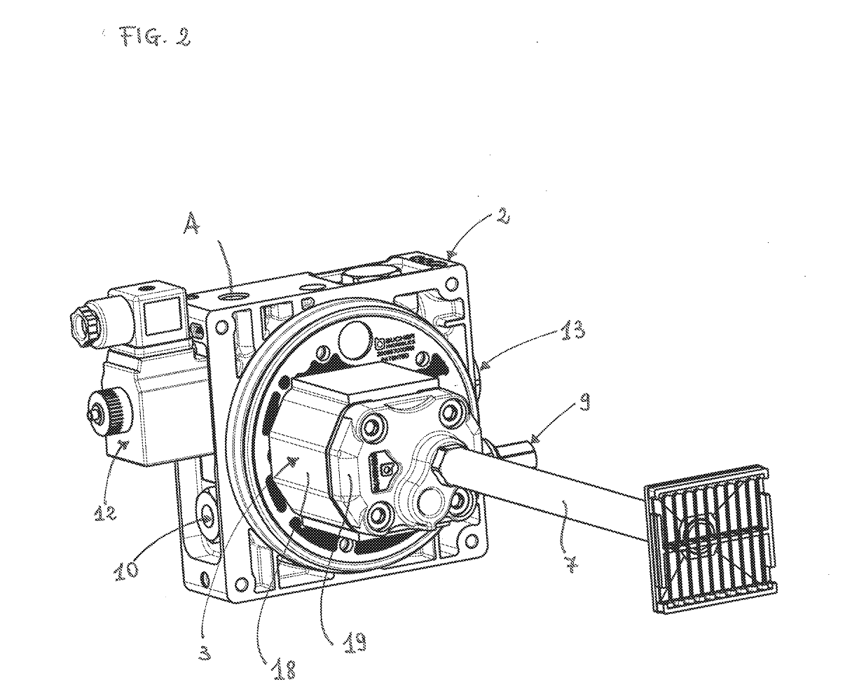

FIG. 1 illustrates a power unit (indicated by the number 1) of a known type for a lift truck. A power pack body 2, a hydraulic pump 3, a hydraulic oil tank 4 and an electric motor 5 are identifiable in the power unit 1. The hydraulic pump 3 and the power pack body 2 are two distinct physical units connected one to the other, as can be seen in FIG. 2.

When the electric motor 5 connected to the pump 3 is activated, there is created:
an internal suction zone 6, which, by means of the channel 7, makes it possible to suction hydraulic oil from the tank 4;
an internal delivery zone 8, which, by means of the gear engagement, makes it possible to pressurize the hydraulic circuit.

Downstream of the pump 3, in the power pack body 2, there is provided a maximum pressure valve 9 capable of limiting the maximum pressure of the system. Upon reaching the set point, the maximum pressure valve 9 discharges the oil towards the tank 4, protecting the system against overpressure. In parallel, a check valve 10 has the task of preventing backflows to the pump 3, that is to say, with the circuit stopped, the oil remains blocked and is unable to flow towards the pump 3. Downstream of the check valve 10, there is a threaded port A for connection of the hydraulic actuator 11 (that is, a cylinder in the case of a lift truck).

Parallel to the port A, there is an unloading valve 12, in this case normally closed so as to ensure that the cylinder 11, once raised, remains blocked in that position. For example, the unloading valve 12 is a manually- or hydraulically-operated, electrical on-off or proportional valve. In this manner, the operator is able to lift a load and move it while keeping it raised. Upon arrival at the destination point, it is sufficient to activate the electrical descent control, thereby opening the unloading valve 12 in such a manner that a passage is opened from the cylinder 11 towards the tank 4.

In order to prevent the descent step from being excessively rapid, there may be provided a flow control valve 13 that is able to restrain the descent within pre-established parameters. The maximum pressure valve 9 and the flow control valve 13 can have a fixed setting or be adjustable in such a manner that the manufacturer of the lift truck can adapt the settings to additional similar lift trucks.

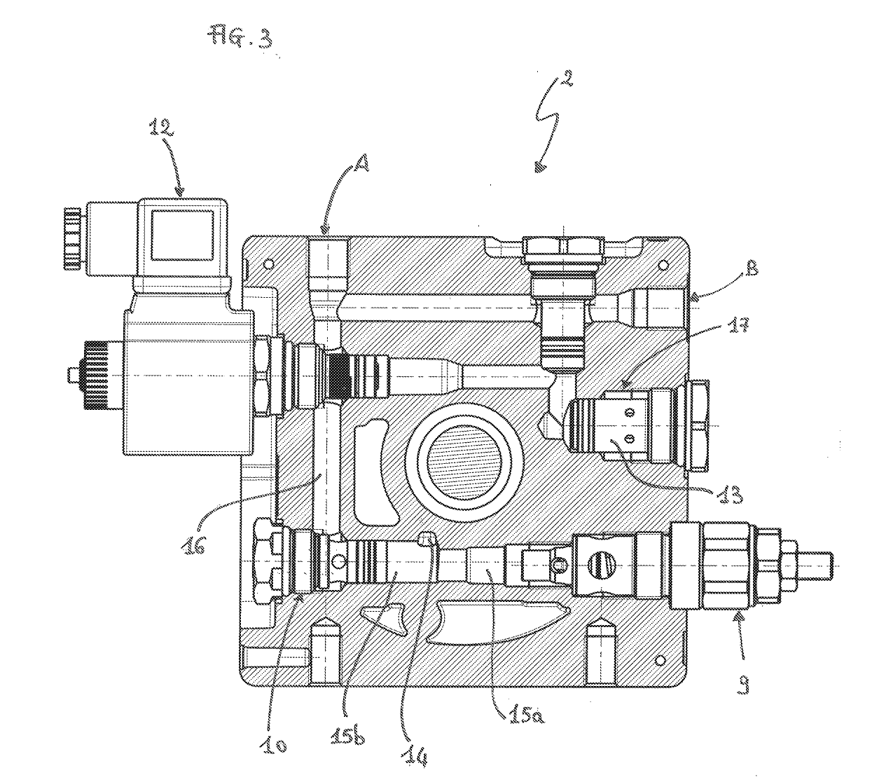

In the power pack body 2 illustrated in FIG. 3, the channel 14 through which the oil enters from the pump 3 is identifiable. This channel 14 forks in two directions: a first direction 15a leads to the maximum pressure valve 9 and a second direction 15b leads to the check valve 10. Downstream of the check valve 10, one observes the channel 16 leading to the ports A, B and connected to the unloading valve 12. This unloading valve 12 separates the port A, B from the discharge line 17.

The hydraulic pump 3 is an external gear pump made up of a main body 18 and a rear cover 19. The main body 18 has balancing bushings 20 and the gaskets 21 thereof (to increase efficiency in specific applications), a driving gear 22 and a driven gear 23.

The mini power pack described in the preceding paragraph proves to be complex in construction, unwieldy and expensive given that several parts must be assembled and related interfaces must be designed ad hoc.

From US2006/0168956 it is known a hydraulic controller (12) comprising an electric motor (121), a hydraulic pump (122), an oil tank (123) and valves (124) for controlling the flow of the oil between the oil tank (123) and a hydraulic cylinder (11).

Another solution of the known type provides for the integration of one or more functions of the hydraulic circuit in the rear cover of the pump. This is a “hybrid” solution employed for example in a mini power pack with simple circuits made up of a check valve and a maximum pressure valve, or only a maximum pressure valve.

This solution is also employed in electrical pumps, which, as is known, combine a hydraulic pump with a motor, but do not incorporate the tank. For example, FIG. 8 shows an electrical pump 31, in which the motor 35 and the pump 33 are connected by means of a flange 34. One of the ports A is visible in the main body 318 of the pump 33. In this specific case, a maximum pressure valve 39 is incorporated in the rear cover 319 of the pump 33. Many functions can also be incorporated on this cover 319, as the cover 319 remains accessible at all times (and thus also the valves incorporated therein) given the absence of the tank.

Even if it may be simple, the incorporation of the circuit functions in the cover of the pump of a mini power pack, entails an intrinsic structural limitation.

In fact, the presence of the tank in mini power packs renders the valves incorporated in the rear cover of the pump inaccessible, resulting in the impossibility of making adjustments such as the adjustment of the set pressure of the maximum pressure valve and manual adjustment of the descending speed.

The lack of accessibility to the valves also makes it difficult o perform maintenance work (such as coil replacement).

Lastly, in “hybrid” mini power packs the following devices must be adopted:
the solenoid valves must be made of materials that are compatible with the hydraulic oil in which they are immersed;
perfectly sealed cable glands must be provided to bring to the exterior the electrical connection needed to supply power to the solenoid.

In this context, the technical task underlying the present invention is to propose a power unit to move at least a hydraulic actuator and that overcomes the drawbacks of the prior art cited hereinabove.

In particular, an aim of the present invention is to make available a power unit for moving at least a hydraulic actuator, in which the hydraulic circuit is easily accessible for adjustment and/or maintenance procedures.

Another aim of the present invention is to make available a power unit to move at least a hydraulic actuator, which is at least structurally simpler, more compact, lighter in weight and more economical compared to the known solutions, while also maintaining unchanged or even improving the levels of performance.

The stated technical task and the specified aims are substantially achieved by a power unit to move at least a hydraulic actuator, comprising the technical characteristics recited in one or more of the appended claims.

Further characteristics and advantages of the present invention will become more apparent from the approximate, and thus non-limiting, description of a preferred, but not exclusive, embodiment of a power unit to move at least a hydraulic actuator as illustrated in the attached drawings, wherein:

FIG. 1 is a lateral view of a mini power pack of a known type, in which the shell of the tank is partially removed;

FIG. 2 is a perspective view of several components of the mini power pack appearing in FIG. 1;

FIG. 3 is a side sectional view of the power pack body of the mini power pack appearing in FIG. 1;

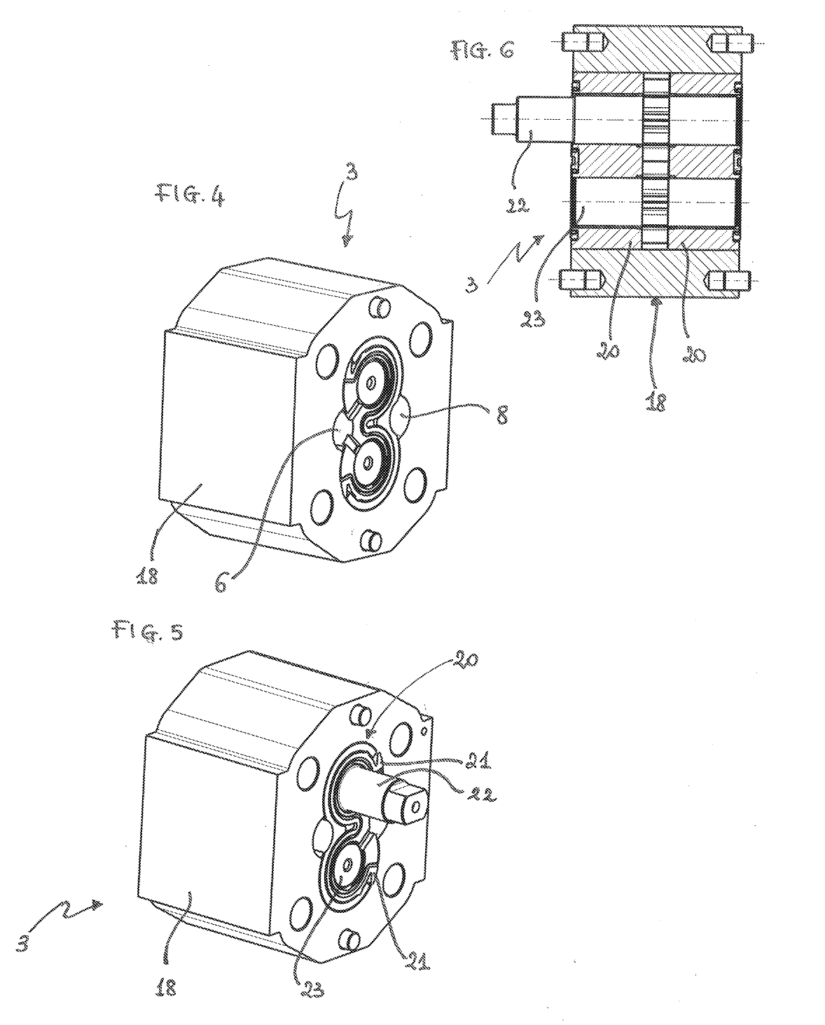

FIGS. 4, 5 and 6 show the hydraulic pump of the mini power pack appearing in FIG. 1, in a perspective view from the tank side, in a perspective view from the power pack side and in a side sectional view, respectively;

FIG. 7 shows the hydraulic circuit of the mini power pack appearing in FIG. 1;

FIG. 8 is a perspective view of an electrical pump according to the prior art;

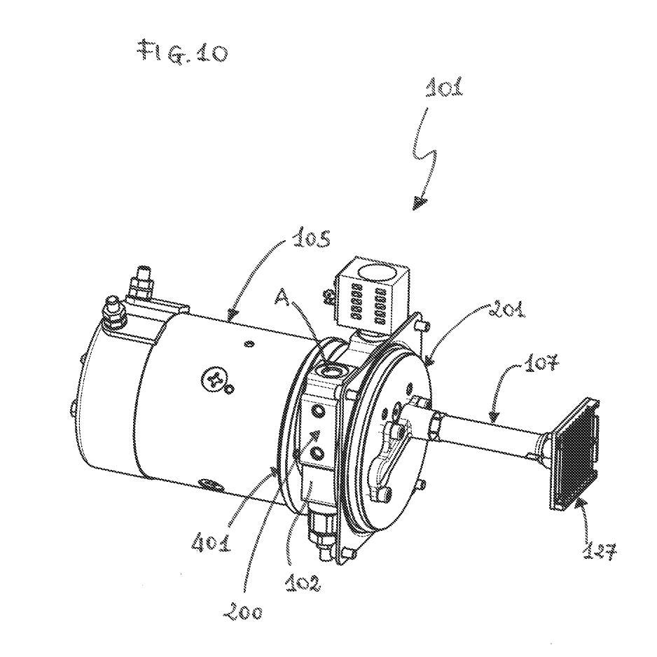

FIG. 9 is a perspective view of a power unit for moving at least a hydraulic actuator, according to the present invention;

FIG. 10 is a perspective view of the power unit appearing in FIG. 9, in which the tank has been removed;

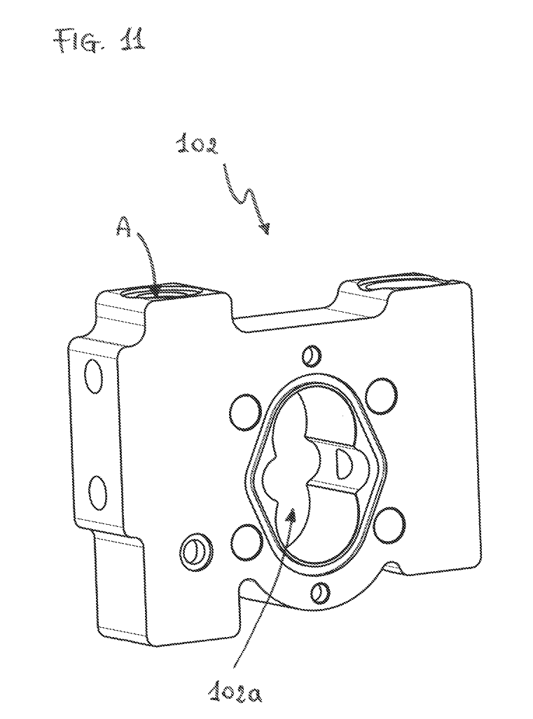

FIG. 11 is a perspective view of a component (power pack body with the housing cavity for hydraulic pump) of the power unit appearing in FIG. 9;

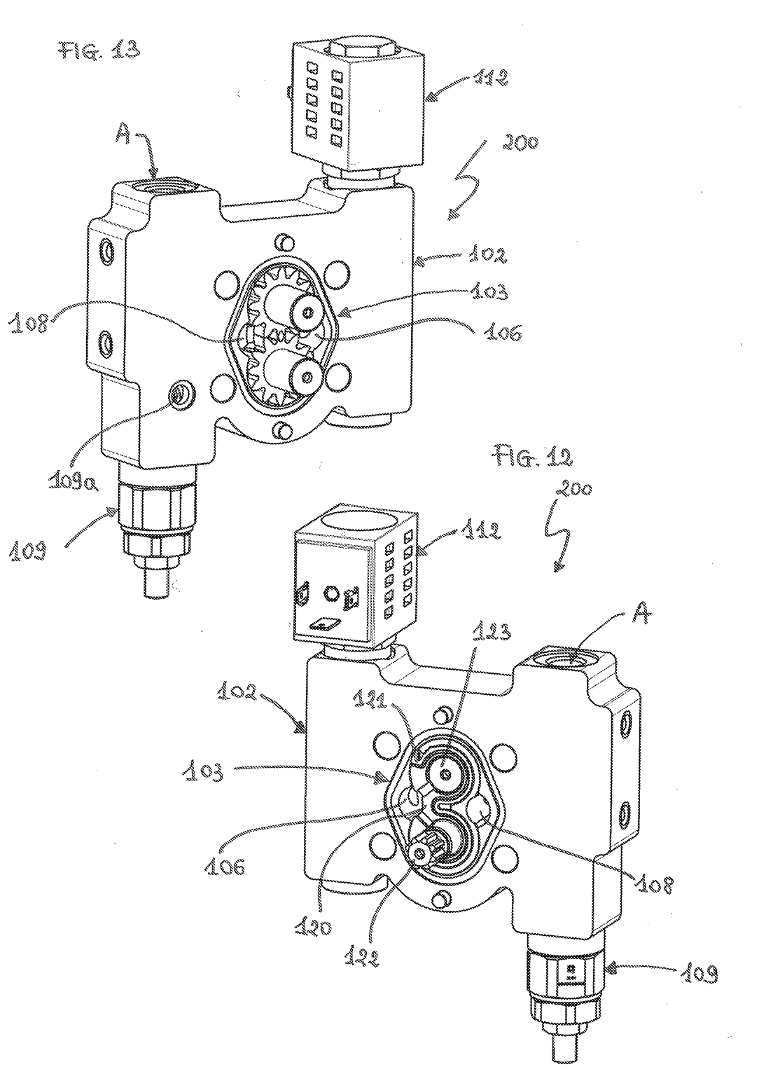

FIGS. 12, 13 and 14 show a component (slice) of the power unit appearing in FIG. 9, in a perspective view from the motorisation means side, in a perspective view from the tank side and in a side sectional view, respectively;

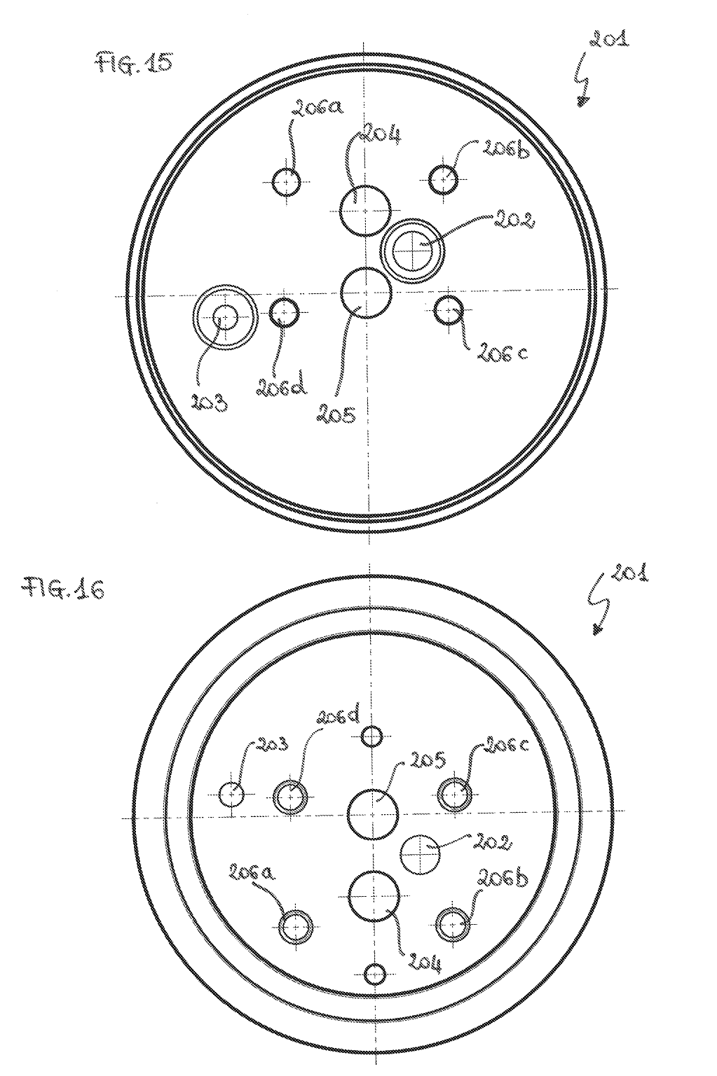

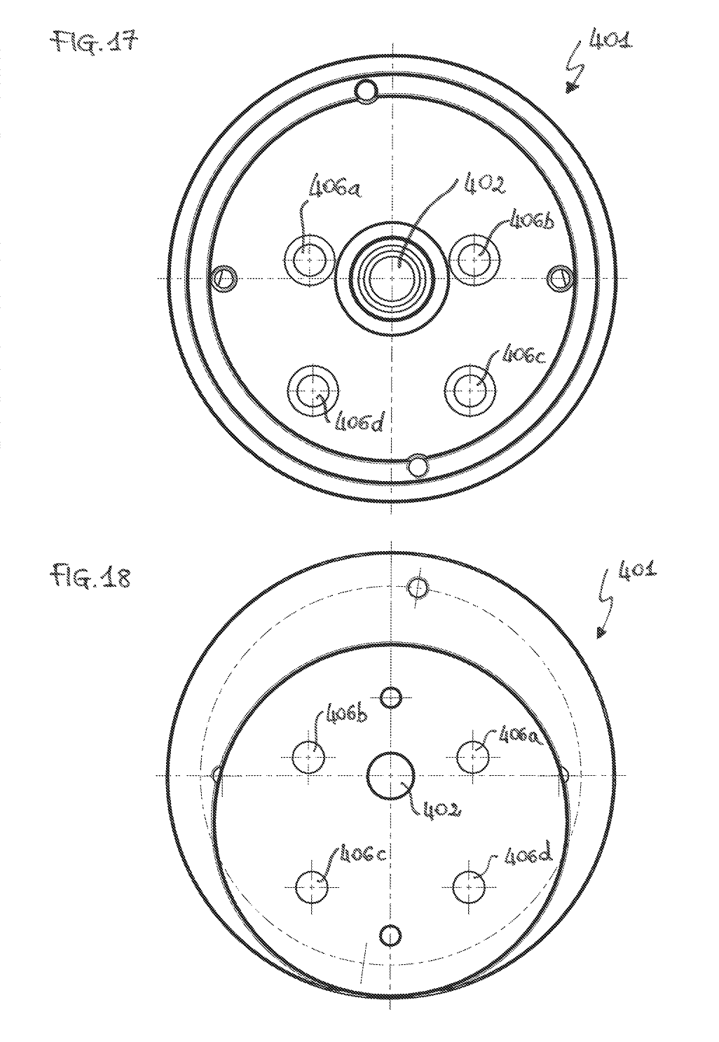

FIGS. 15 and 16 show a component (first flange) of the power unit appearing in FIG. 9, in a frontal view from the tank side and in a frontal view from the slice side, respectively;

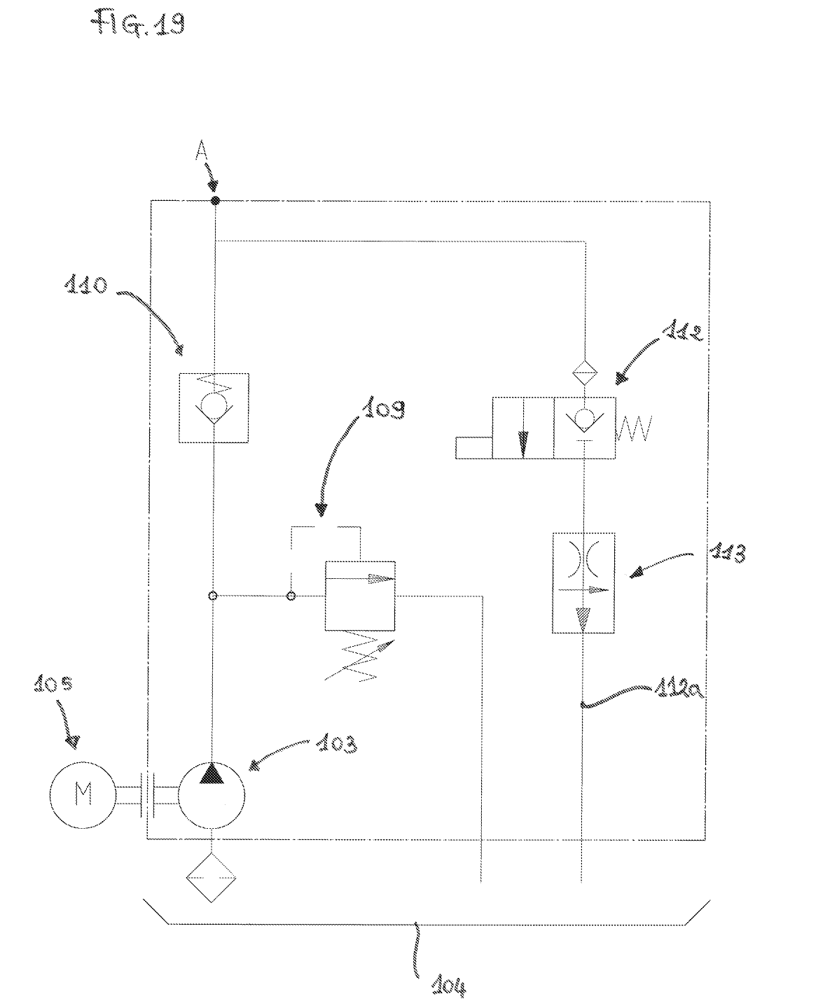

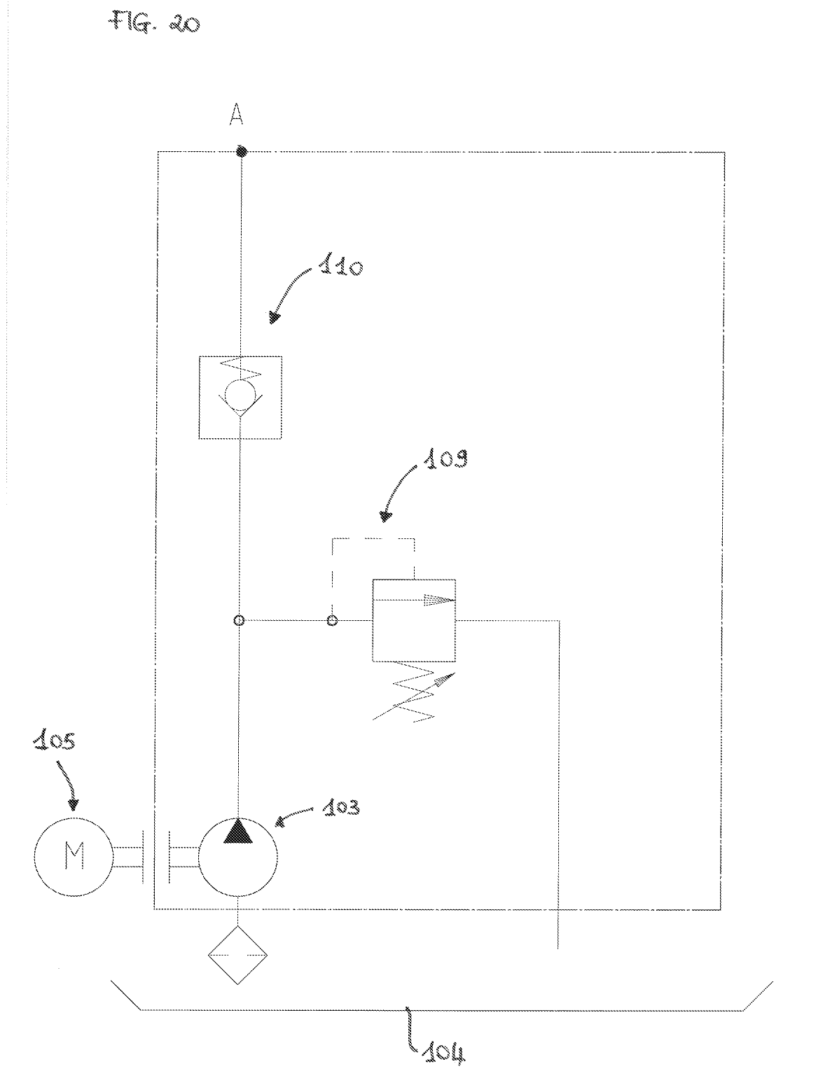

FIGS. 17 and 18 show a component (second flange) of the power unit appearing in FIG. 9, in a frontal view from the motorisation means side and in a frontal view from the slice side, respectively;

FIGS. 19, 20, 21, 22 and 23 are diagrams of as many configurations of the hydraulic circuit extending inside the power pack body of the power unit appearing in FIG. 9.

With reference to FIGS. 9 to 23, the number “101” indicates a power unit to move at least a hydraulic actuator (unillustrated), comprising:
a power pack body 102, and internally thereof a hydraulic circuit extends and is configured so as to perform a plurality of hydraulic functions;
a hydraulic pump 103;
a tank 104 for hydraulic oil;
motorisation means 105 that are operationally active on the hydraulic pump 103 so as to define an internal suction zone 106 for suctioning the oil from the tank 104 towards the hydraulic circuit, and an internal delivery zone 108 for pressurising the hydraulic circuit.

Originally, the power pack body 102 has a through cavity 102a or passage-cavity shaped so as to receive the hydraulic pump 103, which thus proves to be incorporated in the power pack body 102.

The hydraulic pump 103 and the power pack body 102 thus form a self-contained block 200, which is called a “slice” in technical jargon.

As can be seen in FIG. 9, the slice 200 is interposed between the motorisation means 105 and the tank 104.

Preferably, the power pack body 102 is an extruded or bar stock body, made of metal or, for very low-pressure applications, of highly resistant plastic material.

In the embodiment described and illustrated herein, the motorisation means 105 comprises an electric motor. In an alternative solution, for example a pulley is provided.

Preferably, the hydraulic pump 103 is an external gear pump. The hydraulic pump 103 comprises a driving gear 122 and a driven gear 123. The driving gear 122 and the driven gear 123 are housed in the cavity 102a of the power pack body 102.

Preferably, the pump 103 comprises one or more balancing bushings 120 and the gaskets 121 thereof. In an unillustrated embodiment, there are provided two balancing bushings 120, which ensure that the pump 103 is balanced, that is, that the flow rate is kept high even in the presence of an increase in the working pressure. The employment of only one balancing bushing 120 (as in the embodiment shown in FIGS. 12 and 14) is compromise solution that makes it possible to economize, obtaining in any case, a is semi-balanced pump 103. The pump 103 may also not have any balancing bushings 120 at all. In that case, the internal escape routes created at high pressure levels bring about a marked decrease in efficiency, which may be acceptable for some applications that are not heavy-duty applications operating at medium-low pressure levels. Medium-low pressure levels are defined in this context as pressure levels below 50 bars. By way of example, applications for medium-low pressure levels include: lubrication circuits where the working pressure is on the order of 8-30 bars and the pump 103 serves to circulate the oil that lubricates the gears of a transmission (e.g. gear case of a marine inverter, sequential gear boxes for vehicles).

The hydraulic circuit extending in the power pack body 102 according to a first embodiment is described in detail herein below and illustrated in FIGS. 14 and 19.

The hydraulic circuit comprises a maximum pressure valve 109 capable of limiting the maximum pressure of the system. In parallel, there is provided a check valve 110 that prevents backflows towards the pump 103.

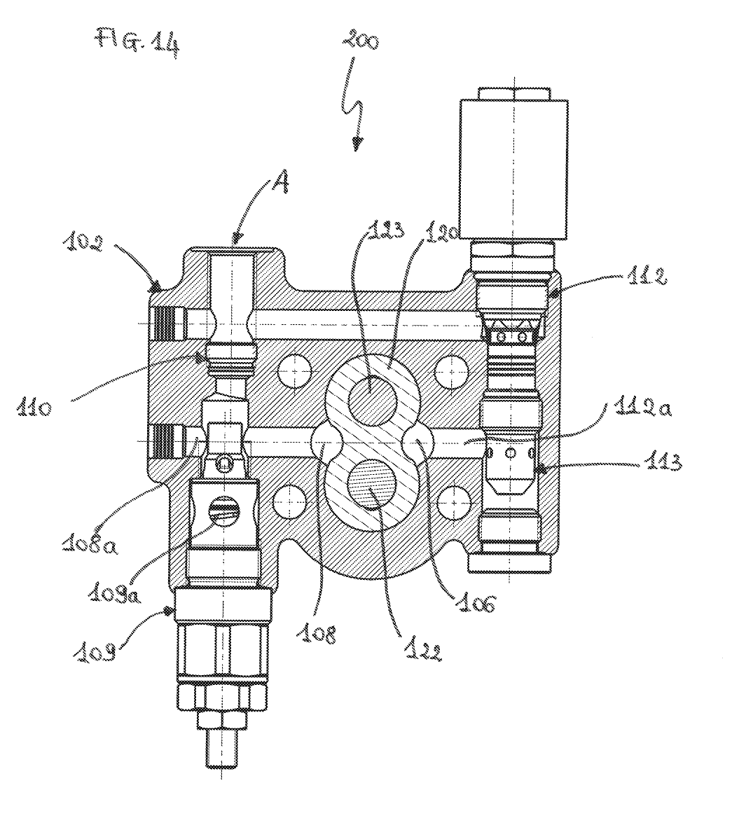

When the set pressure point is reached, the maximum pressure valve 109 discharges the oil towards the tank 104 through a first hole 109a (visible in FIGS. 13 and 14). This first hole 109a leads into the tank 104 directly or passes through a suction pipe 107 that leads into the tank 104.

The internal delivery zone 108 is connected to the maximum pressure valve 109 and to the check valve 110 by means of a second hole 108a (see FIG. 14).

Downstream of the check valve 110 there is at least one port A that can be connected to one or more hydraulic actuators.

Parallel to the port A, there is an unloading valve 112 that separates the port A from a discharge line 112a. If open, the unloading valve 112 opens a route from the hydraulic actuator towards the tank 104, For example, the unloading valve 112 is a manually- or hydraulically-operated, electrical on-off or proportional valve. There is a flow control valve 113 on the discharge line 112a. For example, this flow control valve 113 makes it possible to limit the movement speed of the hydraulic actuator. In an alternative solution (unillustrated), the flow control valve 113 can be regulated externally.

Several variants of the hydraulic circuit extending inside the power pack body 102 are described briefly herein below.

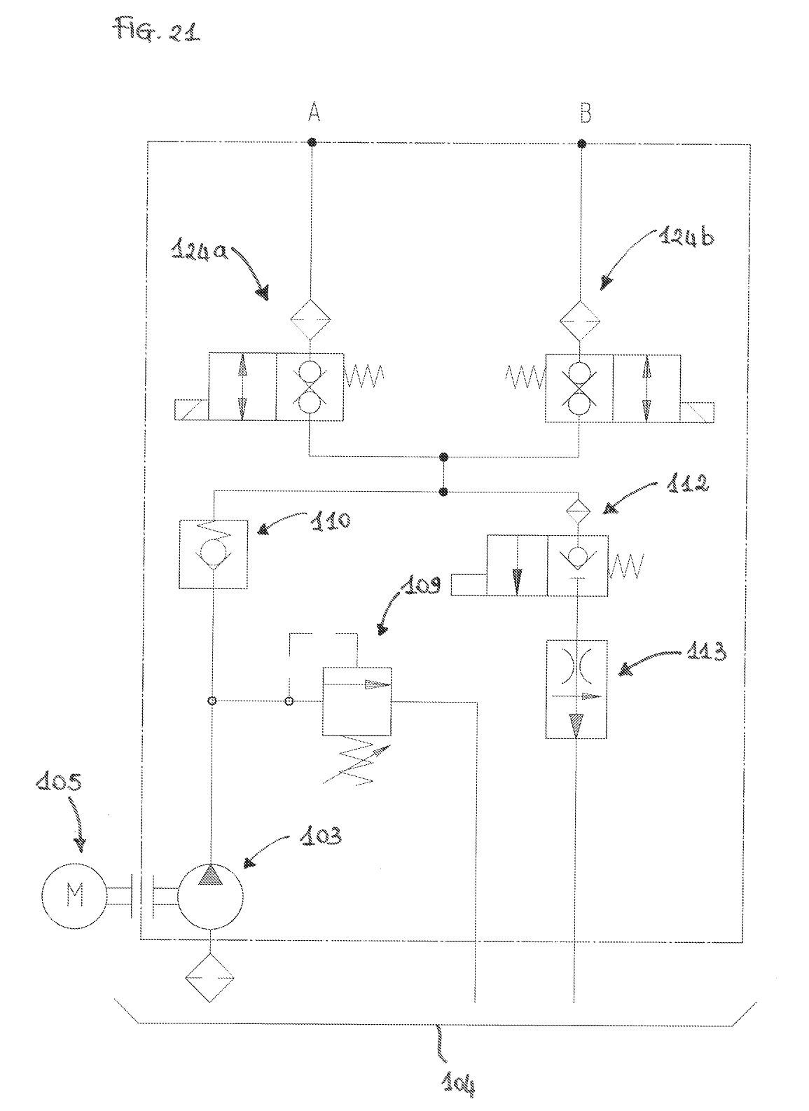

The hydraulic circuit illustrated in FIG. 20 is a simplified circuit comprising only the maximum pressure valve 109 and the check valve 110.

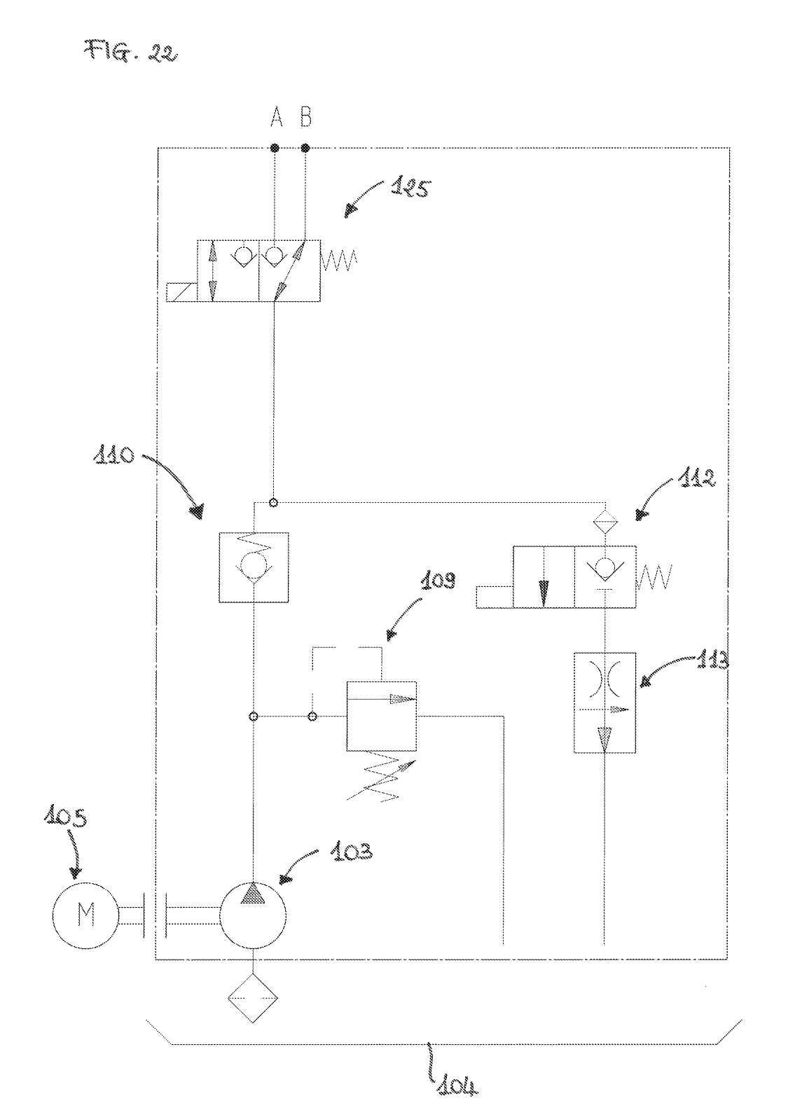

The hydraulic circuit illustrated in FIG. 21 comprises: the maximum pressure valve 109, the check valve 110, the unloading valve 112, the flow control valve 113 and two additional seal valves 124a, 124b suitable for dividing the hydraulic circuit on two ports A, B.

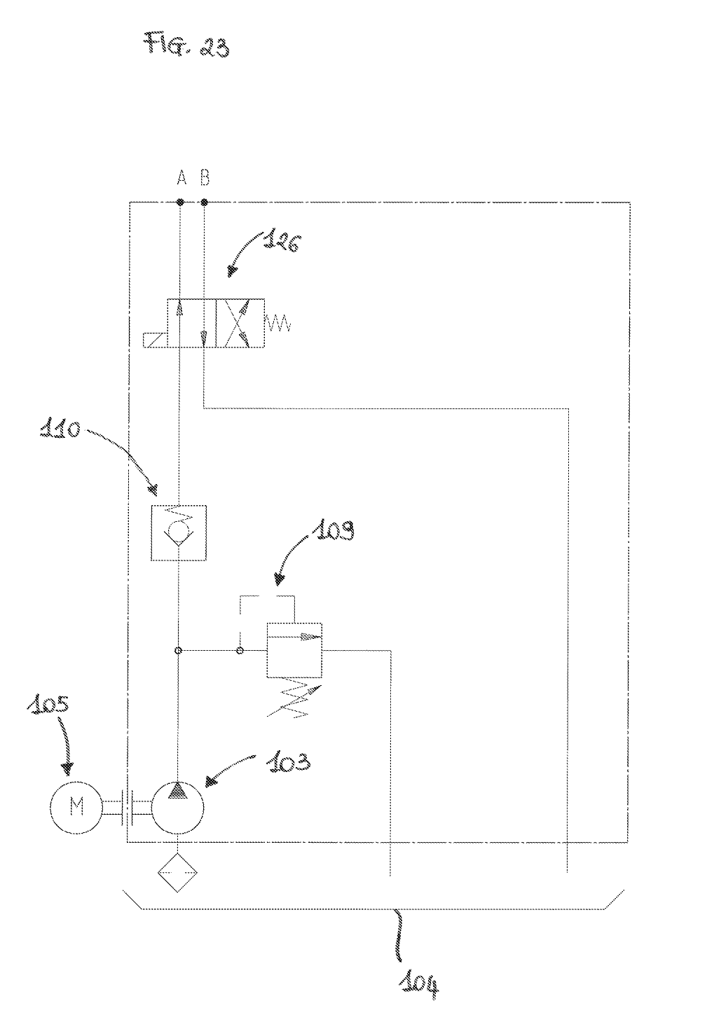

The hydraulic circuit illustrated in FIG. 22 comprises: the maximum pressure valve 109, the check valve 110, the unloading valve 112, the flow control valve 113 and a three-way, two-position seal valve 125 suitable for dividing the hydraulic circuit on two ports A, B.

The hydraulic circuit illustrated in FIG. 23 comprises: the maximum pressure valve 109, the check valve 110 and an exchange valve 126 (either a four-way or three-way valve).

The power unit 101 comprises a first flange 201 for connection between the internal suction zone 106 and the tank 104. The first flange 201 is interposed between the slice 200 and the tank 104 so as to dose the hydraulic circuit from the tank side 104.

The first flange 201 has a first through hole 202, called the suction hole, which puts the internal suction zone 106 of the pump 103 in fluid communication with the suction pipe 107 (visible in FIG. 10). Preferably, the suction pipe 107 is provided with a filtering element 127.

The first flange 201 also has a second through hole 203 directly connecting with the suction pipe 107.

The first flange 201 also has a third through hole 204 suitable for receiving the shaft of the driving gear 122 and a fourth hole 205 suitable for receiving the shaft of the driven gear 123.

The fourth hole 205 may be a through hole or a closed hole (that is, a hollow recess) obtained in the first flange 201.

This fourth hole 205 is present in the case of a semi-balanced pump 103 (that is, with a bushing 120) and in the case of an unbalanced pump 103. This fourth hole 205 may be lacking in the case of a balanced pump 103 (that is, with two bushings), in that support of the shaft of the driven gear 123 is provided by one of the bushings.

The first flange 201 also has fastening holes 206a, 206b, 206c, 206d to receive fastening screws for fastening the first flange 201 to the slice 200. In the embodiment illustrated in FIGS. 15 and 16, there are four fastening holes 206a, 206b, 206c, 206d.

The power unit 101 also comprises a second flange 401 interposed between the slice 200 and the motorisation means 105 in such a manner as to close the hydraulic circuit from the motorisation means 105 side.

The second flange 401 comprises a shaft seal 402 serving the function of isolating the zone submerged in oil with respect to the exterior. The shaft seal 402 is a rubber ring, which, by hugging the diameter of the shaft of the pump 103, ensures the rotary sealing thereof.

The second flange 401 also has fastening holes 406a, 406b, 406c, 406d for receiving fastening screws for fastening the second flange 401 to the slice 200. In the embodiment illustrated in FIGS. 17 and 18, there are four fastening holes 406a, 406b, 406c, 406d.

In an alternative embodiment, the second flange 401 is not present and the shaft seal 402 is incorporated in the motorisation means 105.

In alternative embodiments, the hydraulic pump 103 is an internal gear or vane pump.

In an alternative embodiment (unillustrated), the slice 200 is a monolithic body, that is, the power pack body 102 and the hydraulic pump 103 cannot be physically separated.

The characteristics of the power unit to move at least a hydraulic actuator according to the present invention, prove to be evident from the description provided, as do the advantages thereof.

In particular, owing to integration of the hydraulic pump in the power pack body (in which the gears and the valves now find housing), accessibility to the valves and to the ports is ensured for regulating and setting procedures and/or for performing maintenance work.

Furthermore, the use of a single block (slice) makes it possible to obtain a power unit that is more compact with respect to solutions in which the pump and the power pack is body are physically separated, and with respect to “hybrid” solutions. The greater compactness is a considerable advantage, especially for some applications in which the space occupied constitutes an important planning constraint (for example the application for a lift truck).

Placement of the pump externally of the tank (in fact, the pump is located in the cavity of the power pack body) contributes to the compactness. In fact, as the entire storage capacity of the tank becomes “live storage” capacity, it is possible to use a tank of smaller dimensions.

In addition, the length of the internal channels is reduced, with respect to the solutions of the prior art, resulting in less flow resistance.

The adoption of a power pack body with a cavity housing the pump contributes to reducing the complexity of the structure, the weight and the costs of the power unit.

Incorporation of the pump in the power pack body also makes it possible to reduce the number of components.

The placement of the pump in the cavity of the power pack body also allows for improvement of heat exchange. This advantage is particularly appreciated in heavy-duty applications in which the number of connections and the duration thereof entails overheating of the pump and of the oil contained in the tank.

1. Power unit (101) to move at least a hydraulic actuator, comprising:
a power pack body (102), and internally thereof a hydraulic circuit extends and is configured so as to perform a plurality of hydraulic functions;
a hydraulic pump (103);
a tank (104) for hydraulic oil;
motorisation means (105) that are operationally active on the hydraulic pump (103) so as to define an internal suction zone (106) for suctioning the oil from the tank (104) towards the hydraulic circuit, and an internal delivery zone (108) for pressurising the hydraulic circuit, characterised in that the power pack body (102) has a through cavity (102a) shaped so as to receive said hydraulic pump (103), which thus proves to be incorporated in the power pack body (102) and placed externally of said tank (104).

2. Power unit (101) according to claim 1, wherein said power pack body (102) and said hydraulic pump (103) form a single block or slice (200), which is interposed between the motorisation means (105) and the tank (104).

3. Power unit (101) according to claim 2, further comprising a first flange (201) for connection between said internal suction zone (106) and said tank (104), said first flange (201) being interposed between said slice (200) and said tank (104) so as to close the hydraulic circuit from the tank (104) side.

4. Power unit (101) according to claim 2, further comprising a second flange (401) interposed between said slice (200) and said motorisation means (105) so as to close the hydraulic circuit from the motorisation means (105) side.

5. Power unit (101) according to claim 2, wherein said slice (200) is a monolithic body.

6. Power unit (101) according to claim 1, wherein said power pack body (102) is an extruded or press-formed body.

7. Power unit (101) according to any one of the preceding claim& claim 1, wherein said hydraulic pump (103) is a hydraulic external or internal gear pump.

8. Power unit (101) according to claim 7, wherein said hydraulic pump (103) comprises a driving gear (122) and a driven gear (123), which are housed in said cavity (102a) of the power pack body (102).
